(19) United States
(12) Patent Application Publication
(10) Pub. No.: US 2011/0040688 A1
(43) Pub. Date: Feb. 17, 2011

(54) METHOD, SYSTEM AND COMPUTER PROGRAM PRODUCT FOR THE DECENTRALIZED DISTRIBUTION OF DIGITAL CONTENT

(75) Inventors: Zhiyun Ren, Berlin (DE); Uwe Fankhaenel, Berlin (DE); Shankar Mondal, Krefeld (DE); Ulrich Hammerschmidt, Vienna (AT); Behrend Freese, Kleinmachnow (DE); Joerg Oppermann, Berlin (DE); Jens Meinkoehn, Berlin (DE); Katrin Jordan, Bonn (DE); Andreas Kraft, Berlin (DE)

Correspondence Address: DARBY & DARBY P.C., P.O. BOX 770, Church Street Station, New York, NY, 10008-0770, US

(73) Assignees: DEUTSCHE TELEKOM AG, Bonn (DE); TECHNISCHE UNIVERSITAET BERLIN, Berlin (DE)

(21) Appl. No.: 12/674,615

(22) PCT Filed: Aug. 20, 2008
(86) PCT No.: PCT/DE08/50028

§ 371 Date: Feb. 22, 2010

(30) Foreign Application Priority Data
Aug. 28, 2007 (DE) 10 2007 041 441.4
Nov. 22, 2007 (DE) 10 2007 056 603.6

(51) Int. Cl. G06F 15/16; G06Q 30/00; H04L 9/32

(52) U.S. Cl. 705/59; 705/14.16; 709/219

(57) ABSTRACT

A method for the decentralized distribution of digital content via a network includes providing content with a tag configured to allow at least one of an operator of a download portal and a content provider to track distribution of the content so as to collect data about a number of downloads of the content and about distributors of the content. A distributor downloads the content via the download portal and selects a content consumer for further distribution of the content. The content consumer receives the content and, at least in the case of a first-time utilization of the content by the content consumer, transmits information from the tag about utilization of the content to a server specified by the tag. At least one of the operator of the download portal and the content provider receives the information from the tag about the utilization of the content from the server.

### CROSS REFERENCE TO RELATED APPLICATIONS

This application is a U.S. National Phase application under 35 U.S.C. §371 of International Application No. PCT/DE2008/050028, filed Aug. 20, 2008, and claims benefit to German patent applications DE 10 2007 041 441.4, filed Aug. 28, 2007 and DE 10 2007 056 603.6, filed Nov. 22, 2007. The International Application was published in German on Mar. 5, 2009 as WO 2009/026917 A1 under PCT Article 21 (2).

### FIELD

The present invention relates to methods for the decentralized distribution of digital content. It also relates to a system and to a computer program product for implementing a possible embodiment of the method according to the invention. The content can be content that was already originally present in digital form as well as content that was digitized by means of electronic media for purposes of being stored and distributed.

### BACKGROUND

In order to distribute such content within a community of users or content consumers, either unencrypted download methods and streaming technologies or else methods of digital rights management (DRM) are usually employed nowadays. The digital media data can be commercial content (professional content) whose utilization is restricted, or which call for a payment or which serve commercial purposes such as advertising. By the same token, this data can also be non-commercial content, especially content made available by the users themselves (user-generated content), whose utilization is generally free-of-charge and unrestricted.

Nowadays, content of the above-mentioned type is distributed to an increasing extent especially via the Internet. Originally for technical reasons, but to an increasing degree also due to marketing-strategic considerations, the content is being distributed more and more often via the modality of so-called superdistribution. This process makes use of the participation of content users who, in a manner of speaking, function as multipliers and, in turn, forward or recommend the content to other consumers of said content. In this manner, the owner of the content or the holder of the rights to it can reach a much larger number of potential interested people or content consumers than through the modality of direct marketing or through marketing via traditional trade with its hierarchical structure of dealers. Content in the form of storable files, if applicable, is also passed on to other users, and thus distributed in a decentralized manner, without involving a central server that originally made the content available for download. The distribution among the users can take place, for example, via the Internet, by e-mail or by means of exchangeable data carriers. This, however, has the drawback that the number of direct downloads from the central server only provides a very rough and basically unreliable indication of the degree of distribution of a given content and it is not possible to assess the decentralized distribution, which takes place additionally and often to a far greater extent. For instance, when it comes to distribution via the Internet, when the principle of superdistribution is employed, especially in the case of freely useable and unencrypted content, the content provider has virtually no information about the number of downloads since the downloads no longer take place, or else only to a very small degree, in a centralized manner, that is to say, via one or just a few servers.

Moreover, for content providers, superdistribution has so far entailed the disadvantage that they can obtain little or no information about the routes of distribution of a given content.

### SUMMARY

In an embodiment, the present invention provides a method for the decentralized distribution of digital content via a network. Content made available by a content provider is provided with a tag configured to allow at least one of an operator of a download portal and the content provider to track distribution of the content so as to collect data about a number of downloads of the content and about distributors of the content. A distributor that is a registered user of the download portal downloads the content via the download portal and selects a content consumer for further distribution of the content. The content consumer receives the content from the download portal and, at least in the case of a first-time utilization of the content by the content consumer, transmits information from the tag about utilization of the content to a server of the network specified by the tag. At least one of the operator of the download portal and the content provider receives the information from the tag about the utilization of the content from the server.

### BRIEF DESCRIPTION OF THE DRAWINGS

The invention will be elaborated upon once again below making reference to embodiments. The accompanying figures show the following:

FIG. 1 a graph of the method procedure in a first possible embodiment;

FIG. 2 a graph pertaining to another embodiment;

FIG. 3 a graph of a third possible embodiment of the method;

FIG. 4 another form of the schematic depiction in order to illustrate a variant of the method that is similar to the configuration of the method according to FIG. 3.

### DETAILED DESCRIPTION

In an embodiment, the present invention provides a method that allows decentralized distribution of digital content through the modality of superdistribution, and that also provides information about the type and scope of its distribution. For this purpose, a system and a computer program product are also to be provided.

As set forth in the method according to the invention, the decentralized distribution of the content by users who function as distributors refers to the actual, direct and decentralized distribution of the content by the distributors in question as well as to the alternative possibility that the distributors merely function as multipliers through whom the content is made known preferably to numerous other users. In the latter case, the content is distributed in a decentralized manner in that at least a larger number of users who potentially might be interested in making use of the content are targeted with specific advertising.

According to the method proposed for achieving the objective, digital content in the form of digital media data such as audio, video or image data, or else in the form of digitized documents or applications is made available in a network such as, in particular, the Internet, via a download portal by a content provider who can normally or preferably also be the holder of the rights to the content. Based on the principle of superdistribution, the content provided in this form is downloaded by a registered user of the download portal who functions as a distributor (hereinafter also referred to as distributor), by whom it is forwarded directly to other users who consume the content (hereinafter also referred to as content consumers) or, on the initiative of the distributor, it is retrieved from the download portal by content consumers.

In order to be able to track this decentralized distribution of the content, according to the invention, the content itself—as well as a link that, if applicable, had previously been transmitted to the content consumer in question and that allows the content to be downloaded—is provided with a tag on the initiative of the operator download portal. This tag—which constitutes additional, evaluatable information or data such as, for instance, a user ID that identifies a distributor registered with the download portal, or an ID that identifies the content and that is added to the content or to the link—allows the operator of the download portal and/or the content provider to track the distribution, of the content. In this context, the tag makes it possible to at least collect data about the number of downloads of the content in question and about the distributors who are distributing said content. At least in the case of a first-time utilization of the content by a content consumer who receives this content, the tag added to the content also permits the transmission of information about the utilization that has occurred, whereby this information is transmitted automatically or after permission by the involved content consumer. A network-capable terminal device employed for using the content transmits the appertaining information to the network server specified by the tag. According to an advantageous embodiment of the method, said server is the server of a special tracking platform.

The tag that is to be added to the content—as well as the link that, if applicable, serves to acquire said content—is obtained by the download portal of the tracking platform in accordance with a possible form of interaction between the download portal and the tracking platform, and said tag is then added to the content as well as, if applicable, to the link by the units of the download portal. This can be done on the basis of a business relationship between the operator of the download portal and the operator of the tracking platform. However, it is likewise conceivable for the tracking platform to be maintained by the same operator as that of download portal, so that the tracking platform is directly and physically associated with download portal. In any case, however, the procedures for obtaining the tag and for adding it to the content and, if applicable, to the link are carried out automatically on the units of the download portal and of the tracking platform, which are equipped with the appropriate hardware and software for this purpose.

However, it is also encompassed by the invention that the tag is not obtained by the download portal of the tracking platform, but rather that the tag is added to the content and, if applicable, to the link by the tracking platform itself. This is then done on the initiative of the download portal which transmits the content and, if applicable, the link to the tracking platform for this purpose. The form in which the method is configured (obtaining the tag and adding it to the content by the download portal or adding the tag by the tracking platform on the initiative of the download portal) can also depend, for example, on the relationships between the download portal and the tracking platform, in other words, on whether they interact with each other on the basis of a business relationship between the operators, or whether they are both maintained by the same operator.

In a first basic embodiment of the method relating to the direct decentralized distribution of the content, said content is downloaded from a server (download server) by a user acting as a distributor and using a download device. The decentralized distribution and thus dissemination take place in that the distributor forwards this content or a copy of this content directly to one or more electronic terminal devices suitable for utilizing said content, preferably to terminal devices of other users, that is to say, to content consumers. The content can be forwarded via a network or via interfaces of the download device and of the terminal device of the content consumer, or by the transfer of a data carrier containing the content. Computer devices of the download portal then manage the data as far as the portal user and the content are concerned. In this context, appropriate databases store and manage data about registered users of the download portal, in other words, distributors and data about the content that can be obtained via the download portal.

The content for which the content provider wishes to track the distribution, i.e. information about the scope, type and/or, if applicable, about the routes of distribution, is converted into a certain form or a certain format for the download. For this purpose, the content that is intended by the content provider and/or rights holder for the use of the method and that is made available via the download portal is converted through the addition of the tag into an executable interactive file into which the content and with it data are embedded so as to allow tracking of the content in question. This is preferably done by a tracking platform associated with the download portal in the network.

At least at the time of the first utilization of the executable file in question by means of a network-capable terminal device that is not the same as the download device, the data embedded along with the content into said executable file starts a process that allows a connection to be established between the appertaining terminal device and the server of the tracking platform. If such a connection to this server exists, then data that is obtained from feedback provided by the terminal device that executes said content and/or by the user of said device or by the content consumer is transmitted to said server, and this data provides information about the scope and/or type of distribution of the content. This can be, as already mentioned, a user ID of the distributor, a content ID and, if applicable, personal information about the content consumer. Hence, with this configuration of the method, the above-mentioned interactive executable file constitutes a container, so to speak, which contains the content that itself is not executable but that can only be used by means of a computer application, and which also contains data that allows the distribution of the content to be tracked by starting an automatic routine on a terminal device employed for the utilization of the content when the content obtained from this container is distributed in a decentralized manner.

In conjunction with the above-mentioned elaborations, the formulation according to which said process is automatically started with a network-capable terminal device that is not the same as the download device—at least in the case of a first-time utilization of the executable file—and according to which this process allows a connection to be established between the appertaining terminal device and the server of the tracking platform, will serve to express the following: first of all, the question as to which circumstances cause said process to be automatically started depends on which information about the distribution of the content is desired and how the method is consequently implemented or what the characteristics are of the data that is embedded into the executable file. Thus, it is conceivable that, if possible, every instance of utilization on any given device is to be recorded, in other words, for instance, the utilization should also be recorded if the original downloader himself is using the content on a second or third device (for example, a portable MP3 player or an MP3-capable cellular phone and an MP3 player permanently installed in a vehicle) that differs from the device employed for the download. It is likewise conceivable to also record the utilization on the download device itself. In the final analysis, this depends on the interests of the content provider who is using the method for content distribution. These interests can also be such that the scope of utilization is not recorded on the basis of the number of the devices employed for the utilization but rather only according to the number of different persons who are utilizing the content and, since the original downloader is a registered user of the download portal, the utilization by the downloader himself is not recorded. Naturally, a differentiation on the basis of the devices or persons presupposes that a routine that records the identity of the device and/or that records the identity of the user can be carried out automatically—in a manner of speaking as a preliminary stage or partial process of the process that allows the connection to the server of the tracking—by means of the embedded data on the device that executes the interactive file with the content.

Irrespective of whether the scope of utilization is being recorded in a general manner, independently of the devices or persons involved or else in a manner related to the devices or persons, this recording can be carried out as a function of the type of data collected in this process, conceivably also for statistical purposes, either only in the case of the first-time utilization of the content with a device (download device and/or terminal device), or else in the case of every instance of repeated utilization employing the same device. All of this depends on the interests of the content provider or holder of the rights, whereby it is an option for the person skilled in the art who is implementing the method to appropriately configure the software routines or the embedded data so as to automatically start such a process. Moreover, such a process can be configured in such a way that the connection to the server of the tracking platform is established fully automatically, that is to say, directly, or else only on the basis of permission on the part of the content user in question. For reasons of data protection, preference will be given to the latter case, which is why according to an embodiment of the method, the automatically starting process at least allows the establishment of such a connection, but an actual establishment of the connection might be dependent on permission on the part of the content user. The user can indicate this permission, for example, by undertaking an operating step to this effect (e.g. by pushing a button or activation through a mouse click). The type of data that is transmitted to the server of tracking platform after such a permission (or, if applicable, independently of it) likewise depends on the implementation of the method, that is to say, on the configuration of the tag added to the content, in other words, this depends on the data embedded into the executable file with the content. The data can be restricted exclusively to a digital character string that confirms the utilization of the content, or it can encompass information about the type and configuration of the device employed to reproduce the content. Moreover, it is conceivable for the user to be asked to provide personal information (preferably data of an anonymous type such as age and gender) or else about how or via which route he obtained the content. According to the insight that is the basis of this embodiment of the invention, according to which the executable file is an interactive file, then, in conjunction with the process that is automatically started on the terminal device of a user, the possibility also exists for a more comprehensive dialog between this content consumer and the tracking platform.

The server that receives the data about the utilization or other computer devices of the tracking platform preferably associated with the download portal for the execution of the method stores and manages not only the data about the scope and/or type of utilization of the content, in accordance with the method according to the invention, but also data about registered users of the download portal and data about the content in the form of interactive files that can be obtained via a server of the tracking platform.

Insofar as—for reasons of data protection—the presented configuration of the method is based on permission on the part of the content consumer to establish a connection to the server of the tracking platform or to transmit feedback to a given server about the utilization that has taken place, then, of course, in view of the fact that such permission might be refused, it is not possible to obtain complete statements about the distribution of the content. Nevertheless, by means of the method according to the invention, it is at least quite well possible to obtain at least basic information about the distribution. Depending on the configuration of the embedded data and on the type of utilization of the information gleaned from the feedback, the original downloader as well as the content consumer who has received a copy of the content from this downloader can be motivated to participate in the method. The procedures behind the method, especially also the means and channels for content distribution and for transmitting the embedded data as well as the data that allows the transmission of the information gleaned about the type and/or scope of the utilization of the content, however, are not dependent on the participation by the users. The possible additional motivation for the user to participate only serves to improve the statements that can be obtained about the content utilization.

For purposes of establishing a connection to a server provided for receiving data about the utilization of the content, preferably data containing the URL (Uniform Resource Locator) or the IP address of this server of the tracking platform associated with the download portal is embedded into an executable interactive file that contains the content.

Moreover, data can be embedded into the executable interactive file and can allow a content consumer having the network-capable terminal device employed for the utilization of the content to establish contact with the Internet homepage of the content provider or with the holder of the rights to said content. In this process, this second user, that is to say, the content consumer who receives a copy of the executable file from the downloader or distributor and who executes it on a terminal device suitable for this purpose, can be motivated to participate, in other words, to give his permission by providing feedback about the utilization to the tracking platform. This can be done in that the data embedded into the executable interactive file is data that allows the user to obtain updates for the content from a server of the tracking platform associated with the download portal or from the homepage of the content provider or from the holder of the rights to the content, and/or it allows the user to provide an evaluation of or a comment about the content.

According to a second basic embodiment of the proposed method—in which it is not the content itself that is distributed in a decentralized manner but rather the content announcement that leads to the distribution—a content consumer acquires the content from a server of the download portal or tracking platform. This acquisition, however, takes place on the initiative of the distributor in that he provides the download portal with the address data of the appertaining content consumer, and the content or a link that allows its download is transmitted by the download portal to the appertaining address. Here, too, this is decentralized distribution since the distributor or distributors function as multipliers for the distribution of the content.

Especially the latter embodiment makes it possible, so to speak, to implement a distribution chain in which users of the content function both as content consumers and as distributors, thus allowing content consumers—who, in turn, recommend the content to others or cause other users, that is to say, additional content consumers, to likewise receive the content—to also be take part in a rewards system for distributors. According to such a refinement of the method, a tag comprising a history is added to the content that is transmitted to a content consumer or downloaded by him via the transmitted link. This history is such that the appertaining tag contains information about a distributor who originally caused at least one content consumer to acquire the content, and about one or more content consumers who had previously received the content and, in turn, functioned as distributors. According to this configuration of the method, the content consumers whose data is contained in this history can, if applicable, also obtain the content from various download portals which, in this case, are in a shared network, in other words, they form a multishop structure, so to speak, together with one and the same tracking platform that generates the tag with the history.

According to an advantageous refinement of the method—which is not dependent on whether the content is distributed directly via the distributors themselves or only on the initiative of the distributors (for instance, by passing on the address of potential content consumers to the download portal)—a rewards system as described above is provided. In this context, a distributor who forwards or passes on content to content consumers to an extent that goes at least beyond that laid down by the content provider, is classified as a superdistributor and is rewarded by the content provider with services having a monetary value. The scope of the activities on the part of the distributor that contribute to superdistribution can be determined by means of a user ID that has been added to the content or to an executable file containing the content and, if applicable, to the link as a component of the tag.

Moreover, in accordance with a possible embodiment of the method according to the invention, it is provided that advertising messages are added to the content along with the tag. A business model that implements the method can even be augmented in that the operator of the download portal sends targeted advertising to superdistributors on behalf of advertising agencies or suppliers of brand name products who pay for this service. This results in an additional source of income for the operator of the download portal. It is likewise conceivable for address data of distributors or superdistributors to be sold by the operator of the download portal to advertising agencies or suppliers of brand name products. Preferably, the operator of the download portal will obtain permission from the distributors for this purpose, in advance by making such a permission, for example, an integral part of the agreement with the users who are registered as distributors with him.

Generally speaking, the parties ordering the advertising will not be the same as the content providers. The method, however, also allow for the content provider himself to be the advertiser. In this manner, especially small companies that produce content or even people who produce content as a hobby have the possibility to market their content with little effort and to take advantage of the mechanism of superdistribution. Advantageously, the data pertaining to the number of downloads and the distributors as well as the data transmitted during the utilization of the content can already be aggregated and pre-processed already on the tracking platform. The pre-processed data is cyclically transmitted by the tracking platform to the download portal, where they are made available to the content owners or to the holders of the rights for purposes of further utilization.

Other configuration variants of the method according to the invention allow the distribution of digital content that is subject to digital rights management (DRM). Here, the utilization of the encrypted content is linked to acquiring a license and at least one key for decrypting the content from the content provider or from the holder of the rights. In a configuration variant relating to the direct distribution of content via distributors, a distributor who downloads the content via a download device acquires a license as well as a key for its utilization at the time when the content is acquired, whereby the license encompasses the authorization to forward the content in encrypted form to other users. A second user or content consumer who receives the content from said distributor and who has received the executable interactive file with the content or a copy of it from the downloader within the scope of a decentralized distribution of the content and who executes said file by means of his terminal device thus obtains a license and the key needed to utilize the content directly or indirectly (indirectly if the user already had the utilization rights available to him on a SIM card or another memory card) from the server of the tracking platform through the modality of feedback about the content utilization. Thus, it only possible for the user to utilize the content if feedback is provided to the server of the tracking platform and if he has thus granted his permission for this. Depending on the configuration of the method or on the utilization conditions for the DRM-protected content, a license can be transmitted to the second user, in turn, authorizing him to forward the content in encrypted form to other users.

A system according to the invention is aimed at the direct decentralized distribution of the content consists of a network such as the Internet, of a download portal that belongs to the network and that has computer devices to store databases, of a server that likewise belongs to the network and that provides the content to be downloaded, of at least one download device that is to be incorporated into the network and that serves to download the content from the server that provides it, and of at least one network-capable terminal device of a content consumer that differs from the download device and that is configured to utilize the content. The above-mentioned databases serve to manage users who are registered with the download portal as well as content that can be downloaded via the download portal. A tracking platform is associated with the download portal. This tracking platform comprises hardware-based and software-based means for converting content intended for this purpose into an executable interactive file, also means with which information gleaned about the scope and/or type of the data that allows the distribution of the content can be embedded into this interactive file, and at least one server as well, as storage and management means. The tracking platform also encompasses computer devices with appertaining databases for managing data about registered users of the download portal as well as data about content that is to be obtained in the form of interactive files. As far as the above-mentioned at least one server is concerned, the tracking platform comprises a server for transmitting the interactive file onto a download device that downloads said files, and it also comprises a server that, if applicable, is the same as the above-mentioned server and that receives data that arrives at the server on the basis of feedback from the terminal devices that execute content in the form of interactive files and/or from their users, the content consumers. All of the above-mentioned hardware-based and software-based means of the tracking platform, as well as their servers, can be realized on computer devices that are autonomously in operative communication with the download portal or that are partially or completely physical components of computer devices of the download portal. The latter possibility applies especially to the data management pertaining to the users registered with the tracking platform and to the data about the content converted according to the invention, but not to the content itself. In this context, depending on the implementation, the user data management of the tracking platform can, if applicable, also be identical to the user data management of the download portal. By the same token, under certain circumstances, the content data management of the tracking platform can also access the appropriate database of the download portal that serves for the content data management and, in this process, the content that can be obtained on the basis of the method according to the invention constitutes a subset of the total content available on the download portal, said content can just be identified in this database by a feature to this effect.

According to the insight upon which the invention is based, the download portal consists of one or more computer devices having at least one server for the physical transfer of digital content, and having user and content data management that is logically associated with a tracking platform for purposes of forming the essential elements of the system according to the invention, whereby the units of the tracking platform are autonomous or, if applicable, physical components of the download portal.

The system according to the invention can, if applicable, encompass several download portals, whereby each of these portals is in operative communication with one and the same tracking platform provided according to the invention. In this case, the hardware-based and software-based means and the server of the tracking platform are preferably implemented on autonomous computer devices which are not direct components of the download portals.

The system can be refined in that the tracking platform comprises interfaces for retrieving data that is stored on the tracking platform pertaining to the scope and type of content utilization, so that this data can be further processed and/or prepared for presentation purposes, if applicable, by means of other computers.

In an embodiment of the invention, in terms of the configuration of the method relating to a direct decentralized distribution of the content, a computer program product is provided, which is a data carrier having software for carrying out the method according to the invention, whereby this software consists of a server component for performing the procedures that take place according to the method on computer devices of the tracking platform and of a client component for performing the procedures that take place according to the method on a terminal device for the utilization of content that has been embedded according to the invention into an executable file. In this context, the server component and the client component can be stored as computer program product on different data carriers or on a shared data carrier.

The server component is software by means of which a computer device of the tracking platform converts digital content into an executable interactive file and, data about content utilization obtained from feedback from terminal devices that execute the content is stored, managed and made available for further processing on the tracking platform itself and/or for retrieval at an interface, if this software of the computer program product has been loaded into the main memory of the appertaining computer device and is executed by a processing unit of the computer device. On the initiative of the software, on the basis of the method according to the invention, the content itself as well as data are embedded into the above-mentioned executable interactive file, and said software—in the case of at least a utilization that takes place on network-capable terminal device that is not the same as the download device employed to download the content in question—automatically starts the above-mentioned process in the appertaining terminal device.

The client software allows the utilization of the digital content that has been modified or converted into an executable file according to the invention, in other words, the execution of said interactive file if it has been downloaded into the main memory of the terminal device in question and executed by a processing unit of this terminal device. When the interactive file containing the content is executed, the software makes it possible to establish a connection to a server of the tracking platform. This connection is established either autonomously directly or else on the basis of a query to the user of the terminal device and on the basis of permission granted by the user through an appropriate operating step at the terminal device that reproduces the content, utilizing the data embedded into the interactive file for purposes of addressing the server. Finally, once such a connection has been established, data that is dependent on the type of implementation of the method is transmitted from the terminal device to the server of the tracking platform, on the basis of the procedure of the client software.

The method procedures shown involve the following parties to the method:
the content provider 6, who makes commercial content (against payment or free-of-charge) or non-commercial content available via the download portal 1, whereby said content can, if applicable, be encrypted and, in conjunction with the elaborations below, it is assumed that the content provider 6 is also the holder of the rights to the content in question;
the distributor 7, a user of the download portal 1, who forwards content to at least one other content user or to a small number of other content users, that is to say, content consumers 8, 8′, 8″, or who initiates the distribution of the content to these users;
the superdistributor, a distributor 7, who forwards content to a larger number of users or who initiates its distribution to a larger number of content consumers 8, 8′, 8″. In this context, the content provider 6 can determine under which conditions a distributor 7 is classified as a superdistributor 7, whereby this is assessed, for instance, in accordance with the scope of the content distributed by the distributor 7;
the content consumer 8, 8′, 8″, users of the content, who receive the content from a distributor 7 or superdistributor, or who obtain the content from the download portal 1 on the initiative of the distributor 7 or superdistributor;
the operator of the download portal 1, whereby a tracking platform 1′ is associated with the download portal 1;
the operator of the tracking platform, who might be but is not necessarily, the same as the operator of the download portal;
advertising agencies and/or suppliers of brand name products 9, 10 for whom the distribution of their advertising is made possible in conjunction with the execution of the method.

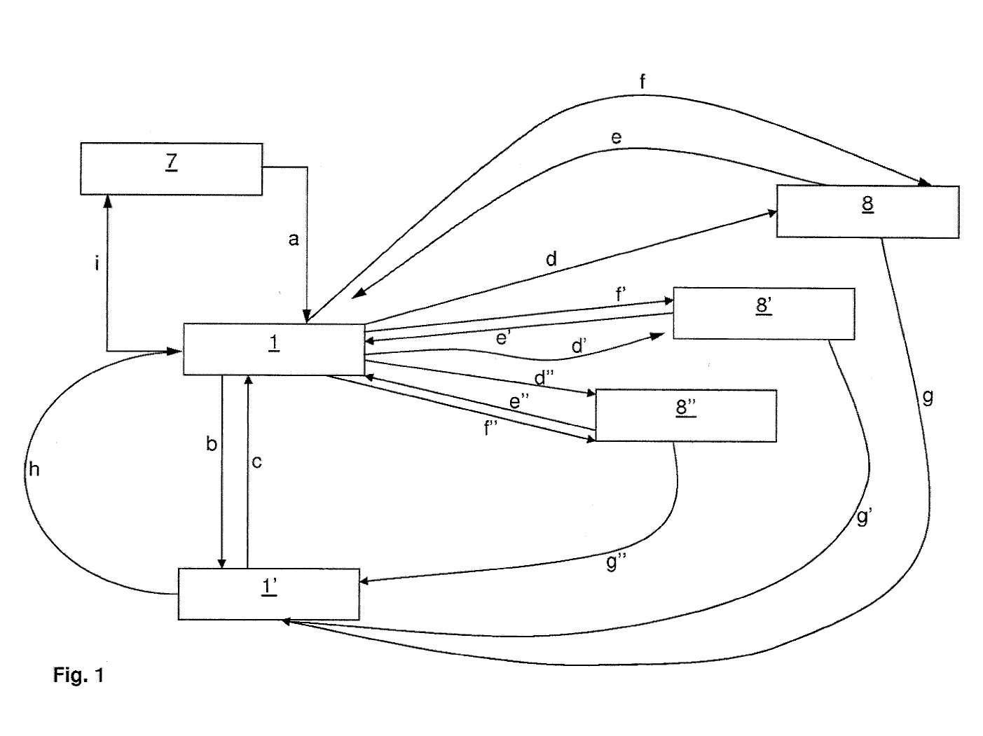

FIG. 1 shows a schematic depiction in the form of a graph of the method procedure according to a possible embodiment of the invention. Accordingly, the procedure takes place as follows:
a) A first user 7 finds content that interests him on the download portal 1 and that he wants to recommend to other users. Consequently, he sends the e-mail addresses of recipients of this recommendation to the download portal where he is currently registered, thus becoming a distributor 7.
b) On the basis of an agreement between the operator of the download portal 1 and the operator of a tracking platform 1′, the download portal 1 sends the provided e-mail addresses and a content ID to the tracking platform 1′ associated with the download portal 1.
c) On the tracking platform 1′, a personalized link or a link provided with a tag is created for each intended recipient of the content recommendation. This link is transmitted by the tracking platform 1′ to the download portal 1.
d) The download portal 1 sends the personalized links to other potential users 8, 8′, 8″ of the content, namely, the intended recipients of said content recommendation.
e) The appertaining recipient or user 8, 8′, 8″ then clicks on the personalized link if the link is of interest to him.
f) The user 8, 8′, 8″, as the recipient of a personalized link, downloads the content indicated by the link from the download portal 1.
g) Once the content link has been downloaded by the user 8, 8′, 8″, the content is used or consumed as intended, as a result of which that particular user 8, 8′, 8″ becomes a content consumer 8, 8′, 8″. On the basis of a tag added to the content, information about the utilization that has occurred is transmitted to the tracking platform 1′ by the terminal device (not shown) that is employed to utilize the content. Depending on the configuration of the method, the content consumer 8, 8′, 8″ can, if applicable, also provide an evaluation of the content along with the transmission of this information. Moreover, this content consumer 8, 8′, 8″ can himself become a distributor if he, in turn, recommends the content to other users.
h) The tracking platform 1′ aggregates the data that has been transmitted to it (the number of downloads, information about which users have recommended the content to which users, information about the utilization of that particular content as well as, if applicable, an evaluation of it), and cyclically transmits the data pre-processed in this manner to the download portal 1.
i) The portal operator or, depending on the configuration of the method, also the content provider 6 (not shown in the figure) can evaluate the data and identify particularly active distributors 7. They can then be rewarded with services having a monetary value and can be targeted with specific advertising.

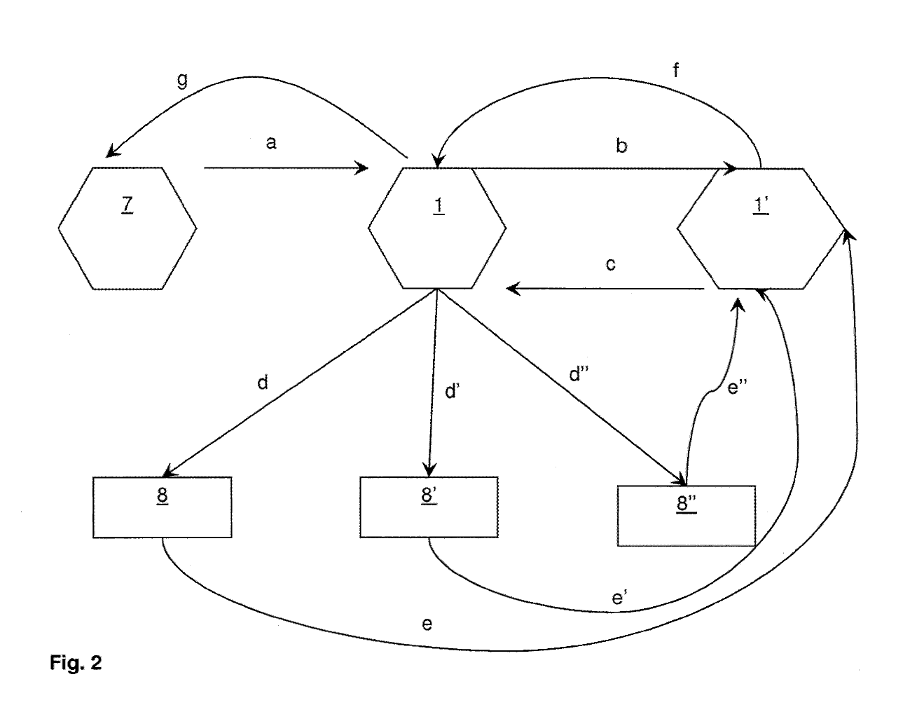

FIG. 2 shows another possible procedure of the method according to the invention, likewise in the form of a graph. Accordingly, the procedure takes place as follows:
a) A first user 7 of the download portal 1 would like to recommend a certain content to other users 8, 8′, 8″. For this purpose, he sends the e-mail addresses of the recipients of this recommendation to the download portal 1 where he is registered at this point in time.
b) On the basis of an agreement that exists between the operator of the download portal 1 and an operator of a tracking platform 1′, the download portal 1 sends a request for a tag to the tracking platform 1′ associated with it. Along with the request, data, preferably a user ID pertaining to the distributor 7 who has recommended the content, and the address data of the users 8, 8′, 8″ who are to receive the recommendation, are transmitted to the tracking platform 1′.
c) Using the data cited in b), the tracking platform 1′ generates tags and transmits them to the download portal 1.
d) The download portal 1 distributes the recommended content with a tag that has been associated with it to the intended recipients or users 8, 8′, 8″. In addition, advertising that is tailored to the recipient (on the basis of data acquired, if applicable, from previous tracking operations) can be added to the content.
e) A user 8, 8′, 8″ who receives the content then utilizes or consumes this content and becomes a content consumer 8, 8′, 8″ in this process. The terminal device (not shown) employed for the utilization transmits information about the utilization that has occurred to the tracking platform 1′. In conjunction with this and as a function of the configuration of the method, the content consumer 8, 8, 8″ using the content can provide an evaluation of the content to the tracking platform 1′.
f) The tracking platform 1′ aggregates the received data and cyclically sends the appropriately pre-processed data to the download portal 1.
g) The operator of the download portal 1 or the content provider 6 in question (not shown in the figure) can evaluate the data obtained from the tracking platform 1′ and can reward particularly active distributors 7, who are then classified as superdistributors, with services having a monetary value

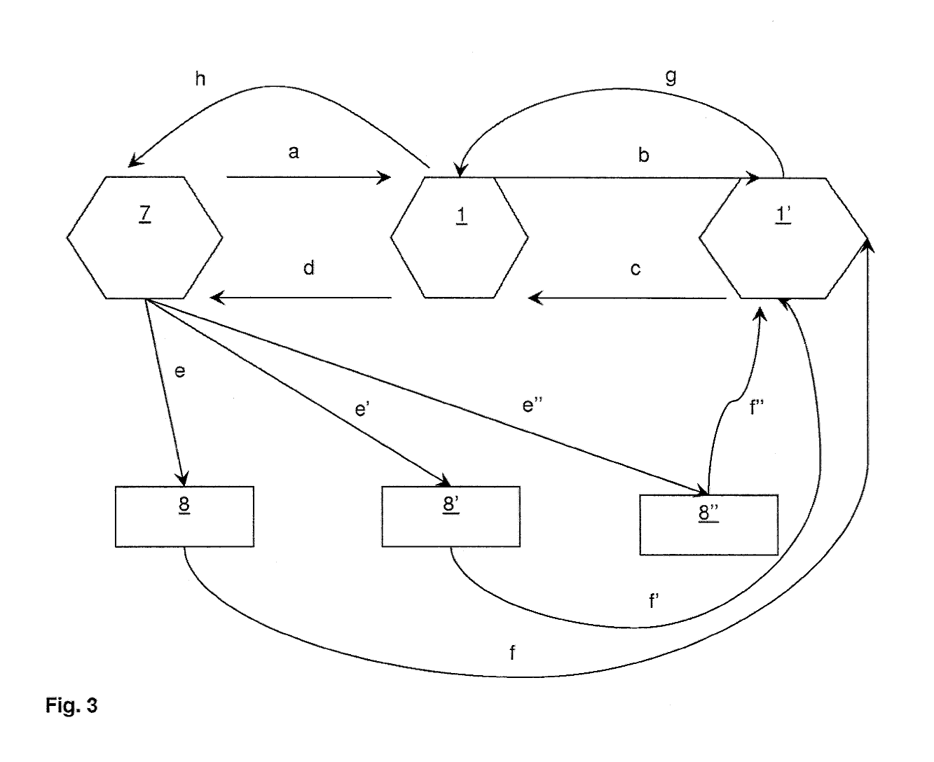

A third possible configuration of the method is shown in the graph of FIG. 3. It refers to an embodiment of the invention in which the decentralized distribution of the content in the form of its decentralized dissemination is done by a user 7 who downloads the content from the download portal and forwards or distributes it to other users 8, 8′, 8″. In the configuration of the method shown by way of an example, the units of the download portal 1 provide the content with the tag previously obtained from the tracking platform 1′. According to the depiction in FIG. 2, the following procedure takes place:
a) A first user sends to the download portal a request to download content he has selected.
b) On the basis of an agreement that exists between the operator of the download portal and the operator of a tracking platform, the download portal sends a request for a tag to the tracking platform. In conjunction with this request, the download portal transfers to the tracking platform 1′ an identifier (for example, a user ID) pertaining to the first user who has requested the content and who is registered with the download portal.
c) The tracking platform 1′ generates the requested tag using the identification feature transmitted to the first user for this purpose and then transfers it to the download portal 1.
d) The first user (according to item a)) downloads the content he had requested from the download portal 1. This content has been provided with the tag that had previously been generated and transmitted by units of the download portal 1.
e) The first user according to item a) sends the content provided with the tag to another (second) user or transfers said content to this user on a data carrier, becoming a distributor in the process.
f) At least in the case of a first-time utilization (a first-time consumption) of the content by a user who has received it as described in item 5 and who has thus become a content consumer 8, 8′, 8″, the tag added to the content causes information about the utilization that has occurred to be transmitted to the tracking platform 1′. This information can, if applicable, also be transmitted along with the transmission of a user ID that has been newly associated with the content consumer 8, 8′, 8″ or that had already been given to him at an earlier point in time upon his request. Moreover, depending on the configuration of the method, the content consumer has the possibility to give an evaluation of the content he has used.
g) The tracking platform 1′ aggregates the data containing the information it has received in conjunction with the request for the tag and with the utilization of the content. If applicable, the tracking platform 1′ also performs a pre-processing of the information it has received in the form of data. Preferably at regular intervals, the tracking platform 1′ transmits to download portal 1 the data it has aggregated and, if applicable, pre-processed.
h) The download portal or the particular content provider 6 (not shown here) can evaluate this data and, in this process, can recognize users or distributors 7 who have contributed to a great degree to the distribution of the content. These users, who have an above-average “value” for the content provider 6 and for the operator of the download portal 1, and, if applicable, also for advertising companies, are classified as superdistributors and can be targeted, for example, with topic-specific advertising.

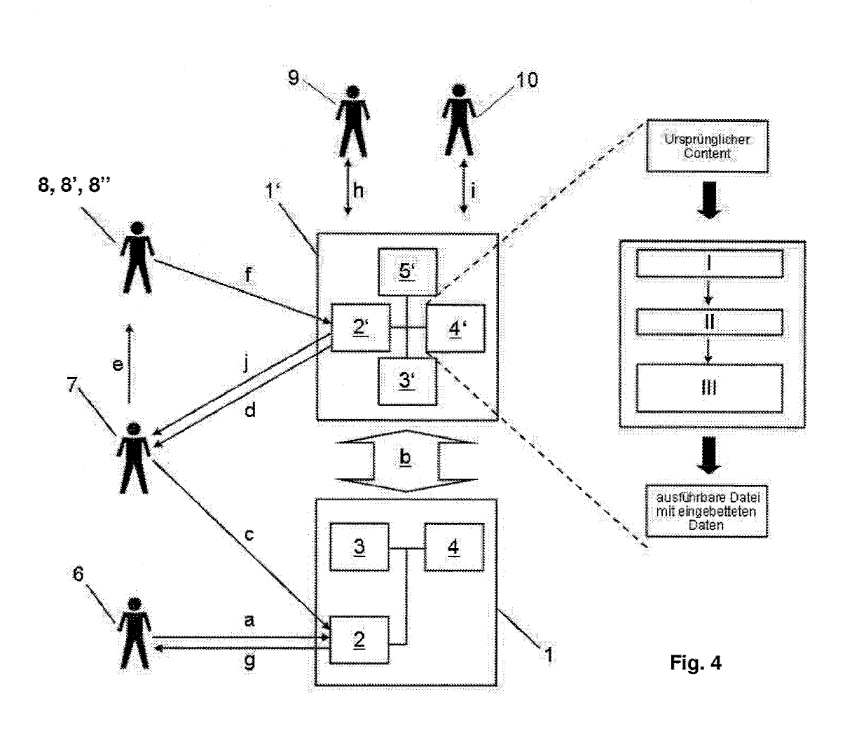

FIG. 4 also serves to illustrate a variant that is comparable to the configuration of the method explained above. It relates to a schematic diagram in which the parties participating in the method and the components of a system that is suitable for carrying out the method can be recognized more readily than in the graphs of FIGS. 1 to 3 that place the method procedures in the foreground. The depiction symbolically includes the content provider 6 and other parties participating in the method who are involved in a business model that makes use of the method, namely, advertising customers 9, 10 of the download portal 1. The variant presented in FIG. 4 also relates to a configuration of the method in which the decentralized distribution of the content goes hand in hand with a direct decentralized distribution of appertaining files with the content by the distributor 7 and with the data embedded in them for tracking purposes. Diverging from the configuration of the method according to FIG. 3, in the variant depicted in FIG. 4, the tag is added to the content by the units of the tracking platform 1′ themselves, whereby the content is converted into an executable file. According to the example presented in FIG. 4, the tracking platform 1′ is directly associated with the download portal 1 and is preferably maintained by the same operator. The units of the download portal 1 and of the tracking platform 1′ work together very closely. Thus, for instance, the content is requested via the download portal 1 by a user who functions as a distributor 7, but this content is delivered through a download via a server 2′ of the tracking platform 1′ that works together with download portal 1. The tracking platform 1′ also receives the data that is transmitted by the devices of the content consumers 8, 8′, 8″ and that serves for tracking purposes. Regarding this schematic diagram, the method procedure that serves as the basis will be presented again. It is configured as follows:
a) Following registration with a download portal 1 equipped with user management 3 and content data management 4, content is uploaded by the content provider 6 or by the holder of the rights by means of a network-capable terminal device (not shown) onto a server 2 of the download portal 1 so that said content is available for utilization on the download portal 1.
   Within the scope of the uploading, the uploaded content is designated by the content provider 6 as content intended for the utilization of the method according to the invention. For this purpose, the content provider 6 or the uploader selects an appropriate option that is offered to him through a user interface of the download portal 1.
b) On the basis of its designation as content intended for tracking the distribution, the uploaded content is transmitted for purposes of its management by the download portal 1 to the tracking platform 1′ associated with the download portal 1, said tracking platform likewise having user management 3 and a management module 4′ that manages content data. The hardware-based and software-based content management module 4′ of the tracking platform 1′—which also manages the data about content of the download portal 1 that is to be acquired on the basis of the method according to the invention—analyzes (I) the content and converts (II) it into an executable file. In this process, data is embedded (III) into said file by means of which a server 2′ of the tracking platform 1′ can be addressed by a network-capable terminal device for purposes of establishing a connection and for transmitting data or feedback confirming the utilization of the content.
c) A user 7 of the download portal 1 who is registered with the download portal 1 and with the tracking platform 1′ associated with said download portal 1, and who is also managed by being associated a user ID logs in via a network-capable download device (not shown) in order to utilize content at a server 2 of the download portal 1.
d) The user 7 selects content to be downloaded and, in this process, in a menu that is offered to him by the download portal 1, activates the option to acquire said content in the form of an executable interactive file. By means of the download device, he downloads the selected content in the form of the executable interactive file from a server 2′ of the tracking platform 1′. During the downloading of the interactive file, not only the data already embedded in this file, but also data containing information about the user 7, especially the user ID under which the user 7 is registered with the download portal 1, is embedded.
e) The user 7 who has downloaded the content forwards the appertaining interactive file with the content or a copy of this file to at least one other user 8, 8, 8″, thus becoming a distributor 7. The forwarding is done by transmission to a terminal device of that particular other user 8, 8, 8″ via a network or via interfaces of the download device and of the terminal device of the above-mentioned other user 8, 8′, 8″, or via a transfer of a data carrier on which the interactive file is stored.
i) The user 8, 8′, 8″ who has received the executable interactive file or a copy of it then executes said file in order to utilize the content by means of a terminal device (not shown) configured for this purpose, a process in which he becomes a content consumer 8, 8′, 8″. The execution of the interactive file starts an automated process on said terminal device, as a result of which a connection of said terminal device can be established to the server 2′ of the tracking platform 1′. In this context, the content consumer 8, 8′, 8″ is prompted or asked in a menu-driven process to permit such a connection and to permit feedback confirming the utilization of the content to be transmitted to a tracking platform 1′, whereby the example shown assumes that such permission was given.
   A connection is established with the server 2′ of the tracking platform 1″, to which the intended data about the utilization is transmitted. If applicable, this can also preferably refer to anonymized data containing personal information about the content consumer 8, 8′, 8″ that is requested by the latter in a dialog within the scope of granting his permission for the connection to be established with the server 2′ and for the corresponding data to be transmitted.
   After the transmission of this data about the utilization or—if no additional dialog between the content consumer 8, 8′, 8″ and the tracking platform 1′ is envisaged—in parallel to the transmission of the data, the content can be utilized or else it runs on the terminal device of said content consumer 8, 8′, 8″.
   The data about content utilization that was transmitted to the server 2′ is prepared or further processed by computer devices of the tracking platform 1′ or in a tracking module 5, or else it is made ready for retrieval for purposes of such further processing, for example, in order to generate statistics, at interfaces (not shown) of the tracking platform 1′.
g) The content provider 6 or the holder of the rights requests data about the content distribution from the tracking platform 1′.

In accordance with the method procedure shown by way of an example, other conceivable refinements of the method according to the invention, these refinements refer to the following:
h) Against payment, a customer 9 (advertising customer) of the download portal 1 having the appertaining the tracking platform 1′—said customer having signed an agreement to this effect with the portal operator—receives additional data containing advertising information embedded into the executable files that contain the content.
i) Moreover, this customer or other customers 10 of the download portal 1 can buy user profiles of the users—with their permission—who are registered at the download portal 1.
j) Finally, the part of the system consisting of the download portal 1 and the tracking platform 1′ shown by way of an example has a bonus or rewards system. According to this system, at defined points in time stored on the tracking platform 1′, the determination is made as to which user from among the set of users registered as distributors 7 has attained the highest distribution quota—regarding the content downloaded in conjunction with the execution of the method according to the invention—over a period of time preceding said point in time. In this context, the determination of the distribution quota is based on feedback about the content utilization that has been received at the tracking platform 1′. The distributor 7 who has attained the highest distribution quota can then be rewarded from the sales generated from advertising customers and/or purchasers of user profiles, and can be given monetary-value vouchers or free-of-charge downloads of content that is otherwise subject to charges.

All, of the variants of embodiments of the invention explained above can also be refined in such a way that advertising agencies or suppliers of brand name products have the possibility of aiming targeted advertising particularly at superdistributors. This advertising can be transmitted to the superdistributors either along with the content or else separately.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

1 download portal
1′ tracking platform
2, 2′ server
3, 3′ computer unit or hardware-based or software-based means for user management
4, 4′ computer unit or hardware-based or software-based means for content management
5′ tracking module of the tracking platform
6 content provider (holder of the rights)
7 user, distributor
8, 8′, 8″ user, content consumer
9, 10 (advertising) customer

1-17. (canceled)

18. A method for decentralized distribution of digital content via a network, the method comprising:
providing content made available by a content provider with a tag configured to allow at least one of an operator of a download portal and the content provider to track distribution of the content so as to collect data about a number of downloads of the content and about distributors of the content;
downloading, by a distributor that is a registered user of a download portal, the content via the download portal;
selecting, by the distributor, a content consumer that is separate from the distributor for distribution of the content;
receiving, by the content consumer, the content from the download portal; and
at least in the case of a first-time utilization of the content by the content consumer, transmitting, by the content consumer, information from the tag about utilization of the content to a server of the network specified by the tag and receiving, by the at least one of the operator of the download portal and the content provider, the information from the tag about the utilization of the content from the server.

19. The method according to claim 18, further comprising the distributor forwarding the content directly to the content consumer.

20. The method according to claim 18, further comprising the distributor transmitting a link to the content to the content consumer, the link being provided with the tag by at least one of the download portal and a unit interacting with the download portal, the link being configured to enable the content consumer to download the content from the download portal.

21. The method according to claim 18, wherein the content includes at least one of a digital audio file, a video file, an image file, and a document file.

22. The method according to claim 18, wherein the at least one of the operator of the download portal and the content provider automatically receives the information from the tag about the utilization of the content.

23. The method according to claim 18, further comprising the step of acquiring permission from the content consumer before the content consumer transmits the information from the tag about the utilization of the content to the server.

24. The method according to claim 18, wherein the content is provided with the tag by at least one of the download portal and a unit interacting with the download portal.

25. The method according to claim 18, wherein the server is part of a tracking platform, and
wherein the method further comprises:
the download portal obtaining the tag from the tracking platform;
the server of the tracking platform cyclically transmitting to the download portal the information about the utilization of the content.

26. The method according to claim 18, further comprising:
converting, through the addition of the tag, the content into an executable interactive file into which the content and identification data are embedded, the identification data containing at least one identifier that serves to identify the distributor that downloaded the content;
at least in the case of a first-time utilization of the content by the content consumer, executing the executable interactive file in a terminal device associated with the content consumer to automatically establish a connection between the terminal device and the server;
obtaining, by the terminal, the information about the utilization of the content from the tag, the information about the utilization of the content including at least one of a scope and a type of distribution of the content;
transmitting, by the terminal, the information about the utilization of the content to the server,
receiving, by the server, the information about the utilization of the content;
storing and managing, by the server, at least data about registered users of the download portal, data about content that can be acquired in the form of interactive files, and data about the at least one of the scope and the type of utilization of the content.

27. The method according to claim 26, wherein the server is part of a tracking platform, and
wherein update data is embedded into the executable interactive file, said update data allowing the content consumer to acquire an update for the content from at least one of the server of the tracking platform and a homepage of the content provider.

28. The method according to claim 26, further comprising:
initiating, by the distributor, acquisition of the content data by the content consumer by providing the download portal with an address associated with the content consumer; and
transmitting, by the download portal, at least one of the content and a link to the content to the content consumer based on the address.

29. The method according to claim 28, wherein the tag comprises a history containing information about an original distributor that originally initiated acquisition of the content data by at least one consumer of content, and about one or more consumers of content that had previously received the content and, in turn, functioned as distributors by initiating a further distribution of the content to other consumers of content.

30. The method according to claim 29, wherein the other consumers of content includes the content consumer.

31. The method according to claim 29, wherein the tag containing the history is generated by devices of the tracking platform and the history includes information about consumers of content that have received the content via different download portals that are in the network with the tracking platform.

32. The method according to claim 23, further comprising, before the content consumer transmits the information from the tag about the utilization of the content to the server, acquiring an evaluation of the content along with the permission from the content consumer.

33. The method according to claim 18, further comprising:
if the distributor forwards content to consumers of content to an extent that goes at least beyond a standard determined by the content provider, classifying the distributor as a superdistributor and rewarding the distributor with services having a monetary value.

34. The method according to claim 18, wherein advertising messages are provided with the content along with the tag.

35. The method according to claim 26, wherein the content is subject to digital rights management, the utilization of the content being linked to a license, and
wherein the method further comprises:
providing, by the content provider, the content in encrypted form to the download portal;
acquiring, by the distributor, a license and a key for utilization of the content, the license including authorization to forward the content in encrypted form to the content consumer; and
receiving, by the content consumer, the license and the key from at least one of the download portal and the server if the content consumer grants permission for feedback to be provided to the server, such that the content consumer is allowed to utilize the content only if the content consumer grants permission for the feedback to be provided to the server.

36. The method according to claim 35, wherein the license transmitted to the content consumer includes authorization to forward the content in encrypted form to other consumers of content.

37. A system for the decentralized distribution of digital content, comprising:
a download portal connected to a network and configured to provide content to be downloaded;
a computer device connected to the network and configured to store databases for managing users registered with the download portal and content that can be downloaded via the download portal;
at least one download device connected to the network and configured to download the content from the download portal;
at least one terminal device connected to the network, the terminal device being configured to utilize the content,
a tracking platform associated with the download portal, the tracking platform being configured to:
convert the content into an executable interactive file;
embed, in the interactive file, information determined about at least one of a scope and a type of distribution of the content;
manage data about registered users of the download portal and data about content to be acquired in the interactive file;
manage the download portal; and
manage a server configured to receive data that arrives at the server as feedback from the terminal device,
wherein the tracking platform comprises at least one computer device autonomously in operative communication with the download portal.

38. The system according to claim 37, wherein the server includes the download portal.

39. The system according to claim 37, wherein the content includes at least one of a digital audio, a video, an image, or a document file.

40. The system according to claim 37, wherein the data that arrives at the server as feedback from the terminal device is provided by a user associated with the terminal.

41. The system according to claim 37, wherein the data that arrives at the server as feedback from the terminal device is produced by the execution of the executable interactive file by the terminal.

42. The system according to claim 37, wherein the tracking platform is in operative communication with a plurality of download portals, and
wherein the at least one computer device includes an autonomous computer device that is not a direct component of the download portals.

43. A computer readable storage medium having stored thereon computer executable process steps operative to perform a method comprising:
converting, through the addition of a tag, content into an executable interactive file into which the content and identification data are embedded, the identification data containing at least one identifier that serves to identify a distributor of the content, the tag being configured to allow at least one of an operator of a download portal and a content provider to track distribution of the content so as to collect data about a number of downloads of the content and about distributors of the content;
transmitting the executable interactive file to a downloading device;
accepting, by a server of a tracking platform, a connection from a terminal device separate from the downloading device that is requested in response to the terminal executing the executable interactive file when the content is utilized for a first time;
receiving, by the server of the tracking platform, information about utilization of the content from the terminal device, the information about the utilization of the content having been retrieved from the tag; and
storing and managing, by the server of the tracking platform, data about at least one of a scope and a type of utilization of the content.

44. The computer readable storage medium of claim 43 having stored thereon further computer executable process steps operative to perform:
receiving, by the terminal device associated with a content consumer from the downloading device, the executable interactive file; and
at least in the case of a first-time utilization of the content by the content consumer, the terminal device executing the executable interactive file to automatically establish a connection between the terminal device and the server of the tracking platform and the terminal device transmitting information about utilization of the content from the tag to the server of the tracking platform.

45. A computer readable storage medium having stored thereon computer executable process steps operative to perform a method comprising:
receiving, by a terminal device associated with a content consumer from a downloading device, an executable interactive file including content and a tag having identification data, the identification data containing at least one identifier that serves to identify a distributor of the content, the tag being configured to allow at least one of an operator of a download portal and a content provider to track distribution of the content to thereby collect data about a number of downloads of the content and about distributors of the content; and
at least in the case of a first-time utilization of the content by the content consumer, the terminal device executing the executable interactive file to automatically establish a connection between the terminal device and a server of a tracking platform specified by the tag and the terminal device transmitting information about utilization of the content from the tag to the server of the tracking platform.
